(19) United States
(12) Patent Application Publication
(10) Pub. No.: US 2010/0100820 A1
(43) Pub. Date: Apr. 22, 2010

(54) USER SPECIFIC MUSIC IN VIRTUAL WORLDS

(75) Inventors: Raquel B. Bryant, Raleigh, NC (US); Ruthie D. Lyle, Durham, NC (US); Olanike Ogunbodede, North Chelmsford, MA (US); Deborah B. Veach, Poughkeepsie, NY (US)

Correspondence Address: Cuenot, Forsythe & Kim, LLC, 20283 State Road 7, Ste. 300, Boca Raton, FL, 33498, US

(73) Assignee: INTERNATIONAL BUSINESS MACHINES CORPORATION, Armonk, NY (US)

(21) Appl. No.: 12/233,621

(22) Filed: Oct. 19, 2008

(51) Int. Cl. G06F 3/048

(52) U.S. Cl. 715/727

(57) ABSTRACT

A computer-implemented method of providing user specific music for a virtual world environment can include, responsive to an input from a user, associating an event with a music source, wherein the event involves an avatar representing the user within a virtual world executing on a virtual world server and storing, within a client of the user, an association between the event and the music source. The client can monitor a virtual world session, within which the user is represented by the avatar, for the occurrence of the event, and responsive to the client detecting the event, outputting, from the client, audio played from the music source associated with the detected event, wherein the music source is played without involvement of the virtual world server.

### BACKGROUND

The embodiments of the present invention relate to providing user specific music in virtual world environments. Virtual worlds are computer-based, simulated environments intended to allow a user, or users, to interact with simulated real world or fantasy locations. Typically, the virtual world is accessible by the user via a client communicating with an online, remote server executing the virtual world. Virtual worlds provide a variety of geographically separate users with a communal space in which to interact with each other and perceptual stimuli of the virtual world. These virtual worlds provide an interactive environment that represents a shared interest or fantasy of the users.

Within the virtual world, the interactions of the user(s) may be governed by the rules of reality, e.g., gravity, objects being proportionally accurate, realistic locomotion, or governed by a combination of reality and fantasy based existences. Communication in virtual worlds can be a combination of text, instant messaging technologies, sound, graphical icons, visual gestures, and real time voice via Voice over Internet Protocol (VOIP) technology or the like.

Users are often represented within virtual worlds as avatars. Avatars are two or three dimensional graphical representations of the user, or characters of the user, within the virtual world. Through the avatar, the user can move about the virtual world, interact with other avatars, e.g. users, as well as graphical objects within the virtual world. Avatars serve as an onscreen persona for the user and, as such, can perform actions as well as take on attributes of the user such as status, position, capabilities, skills, or the like.

### BRIEF SUMMARY OF THE INVENTION

The embodiments disclosed herein relate to virtual worlds. One embodiment of the present invention can include a computer-implemented method of providing user specific music for a virtual world environment. The method can include, responsive to an input from a user, associating an event with a music source, wherein the event involves an avatar representing the user within a virtual world executing on a virtual world server, and storing, within a client, an association between the event and the music source. The method can include monitoring, within the client of the user, a virtual world session, within which the user is represented by the avatar, for the occurrence of the event, and, responsive to the client detecting the event, outputting, from the client, audio played from the music source associated with the detected event, wherein the music source is played without involvement of the virtual world server.

Another embodiment of the present invention can include a method of providing user specific music for a virtual world environment. The method can include responsive to an input from a user, associating an event with audio from an online music source, wherein the event involves an avatar representing the user within a virtual world executing on a virtual world server, and storing, within a client of the user, an association between the event and audio from the online music source. The method can include monitoring, within the client, a virtual world session, within which the user is represented by the avatar, for the occurrence of the event and, responsive to the client detecting the event, the client sending a request to the online music source for audio associated with the detected event. The method further can include, responsive to the request, the client receiving, from the online music source, audio associated with the detected event and outputting, from the client, audio associated with the detected event. Audio associated with the detected event can be played without involvement of the virtual world server and in lieu of any audio sent from the virtual world server.

Yet another embodiment of the present invention can include a computer program product including a computer-usable medium having computer-usable program code that, when executed, causes a machine to perform the various steps and/or functions described herein.

### BRIEF DESCRIPTION OF THE SEVERAL VIEWS OF THE DRAWINGS

FIG. 1 is a block diagram illustrating a system for providing user specific music for a virtual world environment in accordance with one embodiment of the present invention.

FIG. 2 is a flow chart illustrating a method of providing user specific music for a virtual world environment in accordance with another embodiment of the present invention.

### DETAILED DESCRIPTION OF THE INVENTION

As will be appreciated by one skilled in the art, embodiments of the present invention may take the form of a system, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “circuit,” “module” or “system.” Furthermore, an embodiment of the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example, but is not limited to, an electronic, magnetic, optical, magneto-optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++, or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The embodiments disclosed herein relate to providing user specific music for virtual world environments during a virtual world session. A user can interact with a virtual world via a virtual world client accessing one or more server(s) executing the virtual world (hereafter “virtual world server”). Within the virtual world, the user can be represented by an avatar. The user can move within, and interact with, the virtual world in the form of the avatar. During the virtual world session, music can be used to emphasize or highlight events occurring within the virtual world such as actions, locations, moods, or personal relationships of the avatar. The user may select specific music sources to be associated with each event involving the avatar.

In accordance with the inventive arrangements disclosed herein, a user in a virtual world session can select a specific music source to be associated with an event involving the user's avatar. This selection can be made via, and stored within, a virtual world client accessing a virtual world server executing the virtual world session. The virtual world client can monitor the virtual world session for the avatar related event and, upon detecting the event, access the specific music source previously associated with the event. The virtual world client can play audio from the music source associated with the detected event responsive to the occurrence of the event.

In this manner, specific audio from the music source, selectable by the user, can be played by the virtual world client privately for the user as a particular event, related to the avatar of the user, occurs in the virtual world. The events involving the avatar can be related to locations, moods, actions, or relationships of the avatar within the virtual world. The music may be private and obtained by the virtual world client in a manner that is independent of, or that does not involve, the virtual world server.

A “session,” as used herein can refer to a semi-permanent interactive information exchange between a virtual world client and a virtual world server. The session can be established upon the virtual world client by logging into the virtual world server at a certain point in time. The session can continue for an indefinite period of time and end at a later point in time when the client is disconnected from the server. As such, a session can be viewed from the perspective of the user, via the virtual world client, and can begin with the presence of the user within the virtual world as an avatar and end with the departure of the user or avatar from the virtual world. Thus, multiple other users may remain within the virtual world, each having his or her own session that may continue irrespective of the sessions of other users.

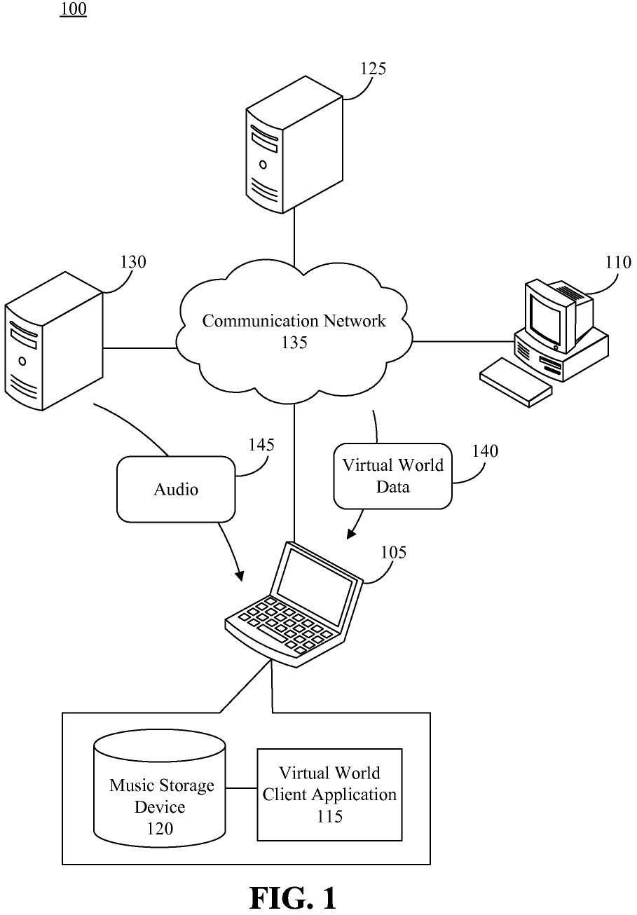

FIG. 1 is a block diagram illustrating a system 100 for providing user specific music for virtual world environments in accordance with one embodiment of the present invention. The system 100 can include one or more virtual world clients (client) 105 and 110, a virtual world server 125, and a music source server 130.

The clients 105 and 110, virtual world server 125, and music source server 130 each can be communicatively linked via a communication network 135. The communication network 135 can be implemented as, or include, without limitation, a WAN, a LAN, the Public Switched Telephone Network (PSTN), the Web, the Internet, and one or more intranets. The communication network 135 further can be implemented as or include one or more wireless networks, whether short or long range, and/or mobile. Communication network 135 can facilitate the exchange of data between various virtual world clients logged into virtual world server 125, e.g., virtual world clients 105 and 110, as well as between virtual world clients and the virtual world server, e.g., client 105 and virtual world server 125.

The clients 105 and 110 can be implemented as any of a variety of data processing systems as can virtual world server 125 and music source server 130. A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the data processing system either directly or through intervening I/O controllers. Network adapters may also be coupled to the data processing system to enable the data processing system to become coupled to other data processing systems or remote printers or storage devices through intervening private or public networks. Modems, cable modems, and Ethernet cards are just a few of the currently available types of network adapters.

Client 105, executing virtual world client application 115, can connect and disconnect users from virtual world server 125, and therefore from the virtual world, as well as receive virtual world data 140 from virtual world server 125. Virtual world client application 115 can serve as an interface through which users can interact with virtual world server 125, accepting user inputs and converting those inputs to requests to virtual world server 125. In addition, the virtual world client application 115 can convert virtual world data 140 received from virtual world server 125, to a format usable by a display device associated with client 105.

Client 105 further can request audio from various music sources, whether remote, e.g., music source server 130, or local, e.g., music storage device 120, for playback to the user through client 105. Clients 105 and 110 can be implemented as, for example, computers, mobile computing devices, mobile phones, wireless enabled personal digital assistants, other data processing systems, or the like.

The music storage device 120 can store music selections which may be associated with avatar related events. The music storage device 120 can be integrated within the client 105 or implemented as a peripheral device communicatively linked to the client 105. When integrated within client 105, music storage device 120 can be implemented in the form of local memory, e.g., random access memory or other non-persistent memory, or as a bulk data storage device, e.g., a disc device or other form of persistent memory. When implemented as a peripheral device, music storage device 120 can be implemented as any of a variety of stand alone storage devices, such as stand alone disc devices, e.g., hard drives, CD or DVD readers, as well as removable mass storage devices, e.g., flash memory cards or devices, or media players.

The virtual world server 125 can perform functions such as establishing, maintaining, and terminating the virtual world session. For example, the virtual world server 125 can connect users to the virtual world, thereby establishing a virtual world session with each respective user, e.g., clients 105 and 110. As such, each of clients 105 and 110 can receive virtual world data that is unique to that client or user as the case may be. The virtual world data 140 may include audio, video, data or other instructions that can be executed by each client 105 and 110 to visually render the virtual world upon a display. For example, virtual world data 140 may include audio and/or video (streams) that can be rendered by clients 105 and 110.

The virtual world server 125 can establish communication links with virtual world clients 105 and 110, thereby enabling each virtual world client 105 and 110 to communicate with each other virtual world client via the communication network 135. It should be appreciated that virtual world server 125 can be implemented as one or more computing devices functioning individually, or in tandem with other computing devices, to carry out the operations associated with virtual world server functions in a virtual world session.

Music source server 130 can represent any of a variety of music sources remote from, but accessible to, client 105. As used herein, the term “music source,” can refer to any local or remote music source from which audio can be received by a virtual world client, e.g., client 105, during a virtual world session. For example, music sources can include remote music sources, e.g., music source 130, such as an online audio player or “jukebox,” Internet radio, online music store or local music sources including a memory location local to the virtual world client, or a peripheral memory device accessible by the virtual world client, e.g., audio file player, flash memory card, or the like, e.g., music storage device 120. When the music source 130 is online, the user can specify a particular channel or file to associate with the avatar related event depending upon the type of music source, e.g., designate a particular channel when a music source contains multiple channels.

In operation, a client 105 can log into the virtual world server 125, thereby establishing a virtual world session. The user, working through client 105, can create and control an avatar through which the user can navigate, and interact with, the virtual world during the virtual world session. The user may desire to have specific music selections played responsive to various events related to the avatar that may occur during the virtual world session. Through client 105, the user can associate specific music sources with each event related to the avatar.

Music source-event associations can be stored within memory of client 105. It should be noted that although the user creation of music source-event associations is described as occurring during the virtual world session, the involvement of the virtual world server 125 is not necessary to the creation of music source-event associations. As such, the music source-event associations can be created and/or changed, by the user through client 105, at any time prior to, during, or after a virtual world session.

The client 105 can begin monitoring for an occurrence of any events specified by the music source-event associations. An “event,” as used herein, can refer to any action, change of state, change of location, change of mood, or detection of an object or other avatar, which is related to the avatar of a user, that occurs while the user is logged into a virtual world session. For example, an event can include an avatar action such as running, jumping, or flying in the virtual world. In addition, an avatar related event may be the avatar moving within proximity of other objects within the virtual world, e.g., proximity to a particular building, landmark, other avatar or class of avatars. For example, the avatar related event can be the avatar moving within a predetermined distance, as measured within the virtual world, of a large tree in the virtual world. In another example, the avatar can move within proximity of an avatar belonging to a particular class of avatars, e.g., friends or enemies, within the virtual world. As used herein, a “class,” can refer to any grouping of avatars that share a common set of one or more characteristics or features. These features, or the classes themselves, may be user defined.

The avatar related event also can be a change of state or mood in the virtual world. In one embodiment, the client 105 can query the user as to the mood of the user upon logging into the virtual world server, e.g., at the beginning or at any time during a virtual world session. At predetermined intervals during the virtual world session, for example, the user can be queried by client 105 as to any change of mood. Alternatively, the user may manually change mood at any time during the virtual world session. Any change in mood of the user, and therefore the avatar, can be considered an avatar related event.

Using virtual world data 140 received from the virtual world server 125, client 105, can monitor for the occurrence of any avatar related events that are listed among the music source-event associations. Responsive to client 105 detecting an avatar related event from the music source-event associations, the client 105 can output audio from the music source associated with the detected event. In one embodiment, the client 105 can access a local music source, such as music storage device 120, for audio associated with the detected event. For example, the user can associate a particular audio file, from a plurality of audio files stored on a hard drive within client 105, with each of a plurality of events related to the avatar. Responsive to the detection of a particular avatar related event, the client 105 can retrieve the associated audio file from the hard drive and initiate the playing of audio from the local music source through client 105, e.g., play the audio file.

In another embodiment, responsive to client 105 detecting the event, client 105 can access a remote music source, e.g., music source server 130, for audio 145 associated with the detected event. For example, music source server 130 can be an online music source. Music source server 130 can receive, via communication network 135, a request from client 105 for audio 145, associated with a particular avatar related event, e.g., an event within the virtual world relating to the avatar associated with client 105. Responsive to the request, client 105 can receive audio 145 from the remote music source 130 via communication network 135. In this manner, the client 105 can bypass virtual world server 125 when accessing music source server 130 or music storage device 120, thereby executing the retrieval and outputting of audio from either local or remote music sources independently of virtual world server 125. As used herein, “output” or “outputting” can include, but is not limited to, storing data in memory, e.g., writing to a file or other output device, playing audio from a music source, sending or transmitting to another system, exporting, or the like.

It should be noted that the selection of the music-event associations, the monitoring and detecting of avatar related events, and the outputting of audio played from the music source can be executed within client 105. As such, excluding receipt of virtual world data 140 from the virtual world server 125 by client 105, the system 100 can execute the inventive arrangements disclosed herein within client 105, independently of virtual world server 125. In addition, particular audio output by client 105 may not be transmitted to virtual world server 125, and as such can be private to client 105, the creator of the music source-event association for the particular audio. As used herein, “private” can refer to audio data which is chosen and accessible to a particular virtual world client. Although the particular virtual world client may “share” the audio data, or information related to audio data, e.g., title or artist information related to the audio data, with other virtual world clients, the audio data is not server based and therefore cannot be accessed by another virtual world client without permission from the particular virtual world client.

In one embodiment, client 105 and client 110 each can be logged into virtual world sessions within a same virtual world executed on virtual world server 125. Each client will be represented by a particular avatar within the virtual world. The appearance of the particular avatar of client 105 within the virtual world can be changed when the client 105 outputs audio that is private and specific to client 105. This change of appearance can alert client 110 that client 105 is outputting private audio. Responsive to the detection of the change of appearance of the avatar of client 105, client 110 can request receipt of private audio being output on client 105. In that case, the virtual world server 125 may be involved in the request for, and receipt of, the private audio by client 110 from client 105. The sending/receiving of private audio may be a direct stream between client 105 and 110, e.g., a peer to peer connection, streamed audio from client 105 to virtual world server 125 and then to client 110, etc. In another aspect, client 105 may simply provide a description of audio being listened to by client 105, e.g., title artists, etc., to client 110, whether via the virtual world server 125, directly, or through some other means.

During the interval that audio from the music source associated with the detected event is output from client 105, the received audio from virtual world server 125 can be suppressed or eliminated by client 105. For example, as audio from the music source associated with the avatar related event is played, the volume of audio received from virtual world server 125 can be reduced by an amount sufficient to allow audio from the music source to be clearly discernable by the user over audio from virtual world server 125. Alternatively, audio from virtual world server 125 can be completely muted when any audio from the music source associated with the detected event is being output.

Occasionally, the detection of two or more events related to the avatar may occur simultaneously during the virtual world session. In that case, the detected events can be prioritized and the music source associated with each of the simultaneously detected events can be output in a predetermined manner. The prioritization of the avatar related events can be predetermined by system 100 or determined by the user via inputs to the client 105.

The predetermined manner of outputting audio from music sources associated with each of the simultaneously detected events can be implemented in a variety of ways. In one embodiment, audio can be requested by, and output from, client 105 for the music source associated with the detected event having the highest priority. Audio from the highest priority music source can be played without playing any other audio. In another embodiment, the user can be presented with a list of the simultaneously detected events from which the user can select which music source from the list to output, and thus also select an event to which priority is given. In yet another embodiment, audio from the music source associated with each of the two or more simultaneously detected events can be output in succession. For example, a shortened version of audio associated with each detected event can be played in succession and then the cycle repeated when audio for each of the detected events has been output. The cycle can continue until at least one of the detected events no longer occurs.

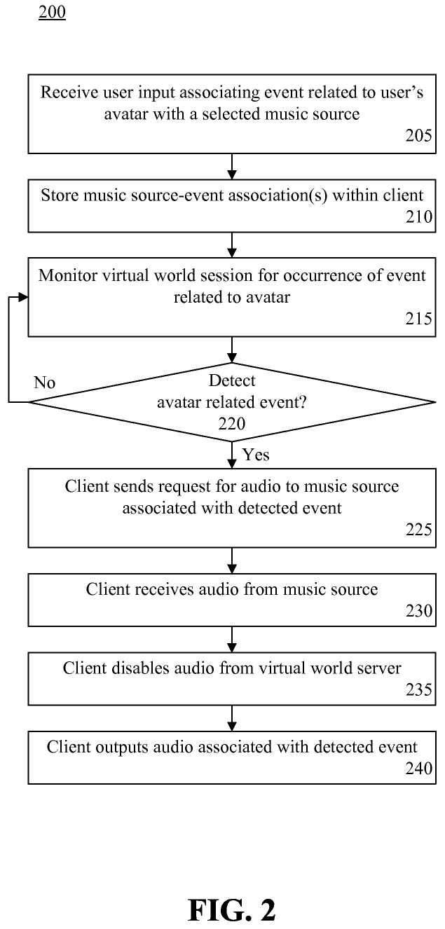

FIG. 2 is a flow chart illustrating a method 200 of providing user specific music for virtual world environments in accordance with another embodiment of the present invention. The method 200 can be implemented using a system as described with reference to FIG. 1, or any other system with the same or similar functionality.

Accordingly, in step 205, a virtual world client can receive a user input associating an event related to an avatar, e.g., the user's avatar, with a particular music source. Using an interface provided by the virtual world client, the user can select, via inputs to the virtual world client, the avatar related event to associate with specific audio. Responsive to the selection of the avatar related event, the event can be associated with the user selected music source.

For example, the virtual world client can present the user with a list of avatar related events from which the user may select. The user can select an event from the list, or alternatively specify a custom event. Responsive to selecting a particular avatar related event, the user can be presented with a list of music sources from which the user may select. The user also may specify his or her own custom music source, whether remote or local. For example, the user may navigate to a local audio file or provide a uniform resource locator (URL). The specified music source can be associated with the selected event. In this manner, the user can successively select a series of avatar related events and associate each of the selected events with a particular, user specific music source.

In step 210, the selected music source-event associations can be stored within the virtual world client. As noted, the music source-event associations can be stored in memory either internal and/or external to the virtual world client. In one embodiment, the music source-event associations can be stored on an internal fixed data storage device of the virtual world client, readily available for recall or editing. In another embodiment, the music source-event associations can be stored on a peripheral or removable storage device. For example, the music source-event associations can be stored on a media player, providing portability to the music source-event associations of the user. As a result, the music source-event associations can be accessed by any virtual world client, logged into by the user, which can be communicatively linked to the media player.

In step 215, the virtual world client can monitor a virtual world session for an occurrence of the event related to the avatar. The virtual world client can use the virtual world data generated by the virtual world server during the virtual world session, to monitor for the occurrence of the event related to the avatar. The client can monitor the virtual server for various activities that can be discerned as event notifications such as particular segments of program codes or event related calculations associated with the avatar of the user. For example, the client can monitor for calculations by the virtual world server to determine the location of the avatar within the virtual world or proximity to an object in the virtual world. In another example, the client can detect a segment of program code that is invoked, such as a script, to initiate an avatar action, e.g., jumping or running. In some cases, a script is triggered by the virtual world server within the virtual world client to trigger or cause an action of an avatar.

In decision box 220, the virtual world client can determine whether an avatar related event, e.g., an event specified in the music source-event associations, has been detected. If so, the method can continue to step 225. If not, the method can loop back to step 215 and continue monitoring the virtual world session.

In step 225, the virtual world client can send a request for audio to the music source associated with the detected event. That is, responsive to detecting the event, the virtual world client can identify the specific music source associated with the detected event. The virtual world client then can request specific audio from the music source for playback responsive to detecting the event. As noted herein, the virtual world client request for audio can be issued to a local music source, e.g., local hard drive, media player, or the like, or to a remote music source, e.g., online music server.

In step 230, the virtual world client can receive audio from the associated music source. The received audio can be received from a local music source or a music source remote from the virtual world client. The received audio can include one or more audio files, e.g., wav, MP3, WMA, or the like, can be output from a channel or “station” of a music source, streamed from an online server, or the like.

In one embodiment, the music source can be a media player with additional memory storage. The media player can store one or both of the audio associated with the detected avatar related event as well as the music source-event associations selected by the user. As a result, the player can be communicatively linked with any suitable virtual world client and provide the information necessary for user specific music to be played back to the user upon detection of an avatar related event.

In step 235, the virtual world client can disable audio received from the virtual world server. The audio associated with the detected event as specified by the music source-event association can be placed in lieu of, or in place of, any audio that is provided from the virtual world server. The disabling of audio received from the virtual world may not be required in all cases. For example, in another embodiment, when the audio from the virtual world server and the audio associated with the detected event are complementary, both may be played concurrently, although the volume of audio from the virtual world server or the user specified audio may be altered or adjusted with respect to one another. The step of disabling audio from the virtual world server, however, can assure that audio associated with a detected event is discernible upon playback from any audio that may also be provided from the virtual world server.

In step 240, the virtual world client can output audio associated with the detected event. In one embodiment, outputting audio from the virtual world client may entail playing back audio on the virtual world client within a period of time subsequent to the detection of the avatar related event and continuing the audio playback concurrent with the duration of the event.

For example, as the avatar enters a geographically defined area within the virtual world, audio from an associated music source can begin playing and continue until the avatar exits the geographically defined area. Alternatively, audio from the music source can be limited to playing only once upon the avatar related event being detected. For example, audio from the music source can last 15 seconds, and be played upon the avatar entering the geographically defined area. The audio, however, can cease after the 15 seconds of output while the avatar may remain in the geographically defined area for a period extending beyond the 15 seconds of audio.

The various embodiments disclosed within this specification are intended as examples, and as such, are not intended to limit the disclosed embodiments. Various approaches to outputting audio from the music source can be implemented to provide the same or similar functionality and/or additional functionalities to the system.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to the embodiments thereof, it will be apparent that modifications and variations are possible without departing from the scope of the invention defined in the appended claims.

What is claimed is:

1. A computer-implemented method of providing user specific music for a virtual world environment, the method comprising:
responsive to an input from a user, associating an event with a music source, wherein the event involves an avatar representing the user within a virtual world executing on a virtual world server;
storing, within a client of the user, an association between the event and the music source;
monitoring, within the client, a virtual world session, within which the user is represented by the avatar, for the occurrence of the event; and
responsive to the client detecting the event, outputting, from the client, audio played from the music source associated with the detected event, wherein the music source is played without involvement of the virtual world server.

2. The computer-implemented method of claim 1, further comprising defining the avatar being within a predetermined distance of a location in the virtual world as an event.

3. The computer-implemented method of claim 1, further comprising defining the avatar being within a predetermined distance of a selected avatar in the virtual world as an event.

4. The computer-implemented method of claim 1, further comprising defining the avatar being within a predetermined distance of an avatar belonging to a selected class of avatars in the virtual world as an event.

5. The computer-implemented method of claim 1, further comprising defining the action of associating a mood with the avatar during the virtual world session as an event.

6. The computer-implemented method of claim 1, further comprising defining an action by the avatar in the virtual world as an event.

7. The computer-implemented method of claim 1, wherein responsive to the client detecting the event, outputting, from the client, audio played from the music source associated with the detected event, wherein the music source is played without involvement of the virtual world server further comprises:
the client sending a request to an online music source for audio associated with the detected event; and
responsive to the request, the client receiving, from the online music source, audio associated with the detected event.

8. The computer-implemented method of claim 1, wherein responsive to the client detecting the event, outputting, from the client, audio played from the music source associated with the detected event, wherein the music source is played without involvement of the virtual world server further comprises, responsive to the client playing audio from the music source, changing the appearance of the avatar representing the user in the virtual world to indicate the user is receiving audio from the music source.

9. The computer-implemented method of claim 1, wherein responsive to the client detecting the event, outputting, from the client, audio played from the music source associated with the detected event, wherein the music source is played without involvement of the virtual world server further comprises playing audio from the virtual world server concurrently with the audio from the music source.

10. The computer-implemented method of claim 1, wherein responsive to the client detecting the event, outputting, from the client, audio played from the music source associated with the detected event, wherein the music source is played without involvement of the virtual world server further comprises the client disabling audio from the virtual world server when outputting audio played from the music source.

11. The computer-implemented method of claim 1, wherein a plurality of associations, each specifying a different event involving the avatar and an associated music source, are stored within the client, the method further comprising:
responsive to the client simultaneously detecting a plurality of events involving the avatar, the client determining a priority for each detected event; and
outputting, from the client, audio played from the music source associated with the event determined to have the highest priority.

12. The computer-implemented method of claim 1, wherein a plurality of associations, each specifying a different event involving the avatar and an associated music source, are stored within the client, the method further comprising:
responsive to the client simultaneously detecting a plurality of events involving the avatar, the client querying the user as to a priority of at least one detected event; and
responsive to an input from the user specifying the priority of at least one detected event, outputting, from the client, audio played from the music source associated with the event having the highest priority.

13. A computer-implemented method of providing user specific music for a virtual world environment, the method comprising:
responsive to an input from a user, associating an event with audio from an online music source, wherein the event involves an avatar representing the user within a virtual world executing on a virtual world server;
storing, within a client of the user, an association between the event and the audio from the online music source;
monitoring, within the client, a virtual world session, within which the user is represented by the avatar, for the occurrence of the event;
responsive to the client detecting the event, the client sending a request to the online music source for the audio associated with the detected event;
responsive to the request, the client receiving, from the online music source, the audio associated with the detected event; and
outputting, from the client, the audio associated with the detected event, wherein the audio associated with the detected event is played without involvement of the virtual world server and in lieu of any audio sent from the virtual world server.

14. A computer program product comprising:
a computer-usable medium comprising computer-usable program code that provides user specific music for a virtual world environment, the computer-usable medium comprising:
computer-usable program code that responsive to an input from a user, associates an event with a music source, wherein the event involves an avatar representing the user within a virtual world executing on a virtual world server;
computer-usable program code that stores, within a client of the user, an association between the event and the music source;
computer-usable program code that monitors, within the client, a virtual world session, within which the user is represented by the avatar, for the occurrence of the event; and
computer-usable program code that responsive to the client detecting the event, outputs, from the client, audio played from the music source associated with the detected event, wherein the music source is played without involvement of the virtual world server.

15. The computer program product of claim 14, the computer-usable medium further comprising computer-usable program code that defines the avatar being within a predetermined distance of a location in the virtual world as an event.

16. The computer program product of claim 14, the computer-usable medium further comprising computer-usable program code that defines the avatar being within a predetermined distance of a selected avatar in the virtual world as an event.

17. The computer program product of claim 14, the computer-usable medium further comprising computer-usable program code that defines the action of associating a mood with the avatar during the virtual world session as an event.

18. The computer program product of claim 14, the computer-usable medium further comprising computer-usable program code that defines an action by the avatar in the virtual world as an event.

19. The computer program product of claim 14, wherein the computer-usable program code that, responsive to the client detecting the event, outputs, from the client, audio played from the music source associated with the detected event, wherein the music source is played without involvement of the virtual world server further comprises:
computer-usable program code that sends, from the client, a request to an online music source for audio associated with the detected event; and
computer-usable program code that, responsive to the request, receives, within the client, audio associated with the detected event from the online music source.

20. The computer program product of claim 14, wherein a plurality of associations, each specifying a different event involving the avatar and an associated music source, are stored within the client, the computer-usable medium further comprising:
computer-usable program code that responsive to the client simultaneously detecting a plurality of events involving the avatar, the client determines a priority for each detected event; and
computer-usable program code that outputs, from the client, audio played from the music source associated with the event determined to have the highest priority.
